(19) United States
(12) Patent Application Publication
(10) Pub. No.: US 2007/0013964 A1
(43) Pub. Date: Jan. 18, 2007

(54) Image forming device

(75) Inventor: Satoru Ono, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/483,001

(22) Filed: Jul. 10, 2006

(30) Foreign Application Priority Data
Jul. 11, 2005 (JP) 2005-201125
May 19, 2006 (JP) 2006-140232

(51) Int. Cl. G06F 15/00

(52) U.S. Cl. 358/406; 358/1.9; 358/518

(57) ABSTRACT

An image forming device for forming an image on a printing medium by forming a latent image on a photosensitive body based on printing data, developing the latent image with coloring material, and transferring the developed image onto the printing medium, wherein when density calibration of an image formed on the printing medium is conducted, the developed image of an image specimen is formed on the photosensitive body or the image of the image specimen is formed on the printing medium based on the printing data for the calibration, color of the formed developed image of the image specimen or the formed image of the image specimen is measured and the image density is adjusted based on the color measurement result, and the printing data for the calibration have data of the image specimen serving as an object of the color measurement and data of a dummy specimen whose latent image is formed before the latent image of the image specimen is formed, is provided.

### CROSS-REFERENCE TO RELATED APPLICATIONS

This application is based upon and claims the benefit of priority from the prior Japanese Patent Application No.2005-201125, filed on Jul. 11, 2005, and the prior Japanese Patent Application No.2006-140232, filed on May 19, 2006, the entire contents of which are incorporated herein by reference.

### BACKGROUND OF THE INVENTION

1. Field of the Invention

The present invention relates to an image forming device for forming an image based on data representing a density gradation value of each color, and more particularly to an image forming device in which a patch pattern of a color measurement object to be used for adjusting the output density of the device can be accurately formed so as to reflect an image forming characteristic of the device and highly accurate calibration is possible.

2. Description of the Related Art

In image forming devices such as printers, an image is generally formed by ejecting an ink or supplying a toner to a printing medium based on image data represented by a density gradation value of each color. The image forming processing is performed so that the density (color value) of the image actually formed on a printing medium becomes the predetermined standard value (target value) for each density gradation value in the image data. Usually, there are differences between individual image forming devices such as printers, and the relationship (density characteristic) between the density gradation value and the color value that is actually outputted correspondingly thereto also differs for each individual device. Accordingly, color correction information (for example, a color correction table) matching the density characteristic of the device is set when the device is shipped, and color correction processing based on this color correction information is conducted with respect to each density gradation value of the image data, which serves as an object, when the image is formed.

However, even with such image forming devices, the environment changes or components deteriorate with time in the course of use, and the state, e.g., of engine parts that actually form an image on a printing medium changes. Because the above-described density characteristic also changes accordingly, the initial color correction information has to be appropriately adjusted to maintain the output results at the target values.

Calibration of image forming devices has been conventionally conducted for this purpose, and a method of using a patch sheet is one of the calibration methods. With this method, a patch sheet is outputted that has printed thereon a plurality of patch patterns with changing gradation values of respective image data for each color of a coloring material (toner or ink) used in the image forming device. The density (color value) of each patch pattern on the patch sheet is measured and the color correction information (for example, a color correction table) is updated so as to correct the difference between the target values that were set in advance with respect to the gradation value of each patch and the actually measured value.

Such technology of calibrating the image forming devices is disclosed, for example, in Japanese Patent Applications Laid-open No. 8-9178 and 4-87454.

However, with the conventional technology, the patch patterns for color measurement that are formed during calibration are sometimes not formed so that they accurately reflect the characteristics of the image forming device at this point in time.

For example, in laser printers in which an electrostatic latent image is formed by irradiating a photosensitive drum with a laser beam via a polygon mirror and image formation is then conducted by developing the latent image, there is a risk of the polygon mirror not reaching a sufficient temperature when the electrostatic latent image of the patch pattern is formed. In this case, there is a possibility that the electrostatic image present on the photosensitive drum is unstable in the patch patterns immediately after the formation of image is started. As a result, the image output density of the patch patterns formed based on the latent image that became unstable will not reflect accurately the usual output density characteristic (in a stable state) of the printing engine in the laser printer. In other words, patch patterns will be formed as an output result including elements other than the output density characteristic. If the aforementioned calibration is performed by using such patch patterns, accurate adjustment of the output density naturally will not be conducted.

Furthermore, in the so-called ink jet printers in which an image is formed by moving a head unit comprising nozzles for ink discharge over a printing medium, the head unit discharges inks, while moving with the same speed in a printing range in the main scanning direction, but the movement state of the head unit, strictly speaking, corresponds to acceleration immediately after the movement is stated and to deceleration immediately before the movement is stopped. Furthermore, because the amount of ink adhering to the unit surface in the ink discharged in the course of such acceleration and deceleration modes is nonuniform, the density of the image formed might also be nonuniform. Therefore, in the patch patterns located at both ends in the main scanning direction where the head unit is in the acceleration and deceleration modes even when the patch patterns of the above-described patch sheet are formed, the output densities of the patch patterns are unstable and cannot accurately reflect the output density characteristic relating to the stable state of the device. As a result, the calibration based on such patch sheets can hardly be accurate.

### SUMMARY

Accordingly, it is an object of the present invention to provide an image forming device for forming an image based on data representing a density gradation value of each color, in which a patch pattern of a color measurement object that will be used for adjusting the output density of the device can be formed so as to reflect accurately the image forming characteristic of the device and highly accurate calibration is possible.

In order to attain the above-described object, the present invention, in accordance with one aspect thereof, provides an image forming device for forming an image on a printing medium by forming a latent image on a photosensitive body based on printing data, developing the latent image with coloring material, and transferring the developed image onto said printing medium, wherein when density calibration of an image formed on the printing medium is conducted, the developed image of an image specimen is formed on the photosensitive body or the image of the image specimen is formed on the printing medium based on the printing data for the calibration, color of the formed developed image of the image specimen or the formed image of the image specimen is measured and the image density is adjusted based on the color measurement result, and the printing data for the calibration have data of the image specimen serving as an object of the color measurement and data of a dummy specimen whose the latent image is formed before the latent image of the image specimen is formed.

Furthermore, in one mode of the above-described invention, a plurality of the photosensitive bodies are provided, and the data of the dummy specimen are data for forming the latent image of the dummy specimen before the latent image of the image specimen on each photosensitive body.

In a preferred mode of the above-described invention, when the image of the image specimen is formed on the printing medium, the image of the dummy specimen is also formed on the printing medium, and the image of the dummy specimen is taken as a marker for determining the position of the image specimen.

In another preferred mode of the above-described invention, color or color density of the dummy specimen is different from that of the image specimen.

In another mode of the above-described invention, the latent image of the dummy specimen is not developed.

In yet another preferred mode of the above-described invention, when the image of the image specimen is formed on the printing medium, the image of the dummy specimen is also formed on the printing medium, and the image of the dummy specimen shows predetermined information relating to the image specimen to a user.

In order to attain the above-described object, the present invention, in accordance with another aspect thereof, provides an image forming device for conducting image formation on a printing medium by repeatedly executing a one-scan printing processing, in which an image is formed on the printing medium based on printing data, while moving a head unit in a main scanning direction, with successive displacement of a relative position with respect to the printing medium in a sub-scanning direction, wherein when density calibration of an image formed on the printing medium is conducted, an image of an image specimen is formed on the printing medium based on the printing data for the calibration, and color of the formed image of the image specimen is measured and the image density is adjusted based on the color measurement result, and the printing data for the calibration have data of the image specimen serving as an object of the color measurement and data of a dummy specimen whose image is formed before and after the image of the image specimen in the main scanning direction for each the one-scan printing processing for forming the image of the image specimen.

In a preferred mode of the above-described invention, the image of the dummy specimen is an image which is uninterrupted in the sub-scanning direction.

In another preferred mode of the above-described invention, the image of the dummy specimen is formed beyond a formation range of the image of the image specimen in the sub-scanning direction.

In another mode of the above-described invention, the printing data for the calibration are provided in a host device for issuing a request for image formation to the image forming device.

In yet another mode of the above-described invention, the printing data for the calibration are provided in the image forming device.

In order to attain the above-described object, the present invention, in accordance with another aspect thereof, provides an image forming device for forming an image on a printing medium by forming a latent image on a photosensitive body based on printing data, developing the latent image with coloring material, and transferring the developed image onto the printing medium, wherein when density calibration of an image formed on the printing medium is conducted, the developed image of an image specimen is formed on the photosensitive body or the image of the image specimen is formed on the printing medium based on the printing data for the calibration, color of the formed developed image of the image specimen or the formed image of the image specimen is measured and the image density is adjusted based on the color measurement result, and the printing data for the calibration have data of the image specimen serving as an object of the color measurement and data of a dummy specimen whose latent image is formed before the latent image of the image specimen is formed and whose latent image is apart from the latent image of the image specimen.

In a preferred mode of the above-described invention, when the image of the image specimen is formed on the printing medium, the image of the dummy specimen is also formed on the printing medium, and the image of the dummy specimen is taken as a marker for determining the position of the image specimen.

In another mode of the above-described invention, color or color density of the dummy specimen is different from that of the image specimen.

Other objects and characteristics of the present invention will be clarified by the embodiments of the invention described below.

### BRIEF DESCRIPTION OF THE DRAWINGS

FIG. 1 is a schematic structural diagram relating to an embodiment of a calibration system comprising a printer that is an image forming device employing the present invention;

FIG. 2 serves to explain the color correction table 18;

FIG. 3 is a flowchart illustrating an example of processing procedure during calibration.

FIG. 4 shows an example of the patch sheet P-S;

FIG. 5 illustrates the process of updating the color correction table 18;

FIG. 6 is an explanatory drawing illustrating a state where the patch pattern PPc is scanned;

FIG. 7 is an explanatory drawing illustrating a state where the patch pattern PPm is scanned;

FIG. 8 is an explanatory drawing illustrating a state where the patch pattern PPy is scanned;

FIG. 9 is an explanatory drawing illustrating a state where the patch pattern PPk is scanned;

FIG. 10 is an explanatory drawing illustrating another example of the-patch sheet data 16;

FIG. 11 is an explanatory drawing illustrating the case where the dummy pattern is also used as a marker pattern for detecting the position of the patch pattern;

FIG. 12 is an explanatory drawing illustrating an example in which the color or gradation value of the dummy pattern is different from those of all the patch patterns;

FIG. 13 illustrates the case where a dummy pattern is not outputted on the patch sheet P-S; and

FIG. 14 is an explanatory drawing for illustrating the patch sheet data 16 in the case of an ink-jet system.

### DESCRIPTION OF THE PREFERRED EMBODIMENTS

The embodiments of the present invention will be described below with reference to the appended drawings. However, the technical scope of the invention is not limited to those embodiments and includes the matter described in the claims and equivalents thereof.

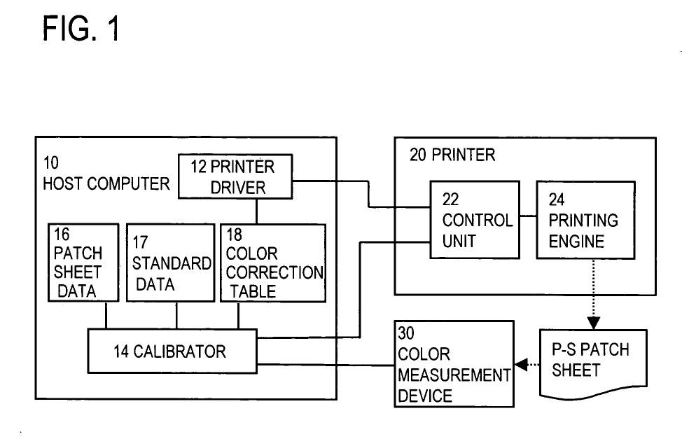

FIG. 1 is a schematic structural diagram relating to an embodiment of a calibration system comprising a printer that is an image forming device employing the present invention. A printer 20 shown in FIG. 1 is an image forming device employing the present invention. In the printer, the patch patterns for adjusting the output density thereof are outputted based on the data such that the patch patterns are formed in a stable state of an image forming unit, the patch patterns that become a color measurement object during calibration accurately reflect the characteristics of the image forming unit, and the calibration accuracy is increased.

A host computer 10 shown in FIG. 1 is a host device of the printer 20 that sends printing requests to the printer 20 and also comprises a function of conducting the output density adjustment of the printer 20. The host computer 10 is connected with a cable to the printer 20 and a color measurement device 30, but may be also connected to a network (not shown in the figure). The host computer 10 comprises a personal computer and is provided with a CPU, a RAM, a ROM, and a hard disk (data storage means) that are not shown in the figure.

As shown in FIG. 1, the host computer 10 is provided with a printer driver 12, a calibrator 14, a patch sheet data 16, a standard data 17, and a color correction table 18.

The printer driver 12 is a driver for the printer 20 and serves to generate printing data for the printer 20, transmit the printing data to the printer 20, and issue a printing command when a printing request is made from the host computer 10 to the printer 20. The printer driver 12 comprises a program describing the processing procedure and, e.g., a CPU for executing processing according to the program.

The calibrator 14 is a unit for conducting the calibration of the printer 20. The calibrator 14 executes a variety of processing operations, e.g., receives a calibration request from the user, issues a command to output a patch sheet P-S, acquires the color measurement results for the patch sheet P-S read out by the color measurement device 30, acquires the color measurement values of each patch pattern PP, and updates the color correction table 18. The calibrator 14 comprises a program describing the processing procedure and, e.g., a CPU for executing processing according to the program and may be mounted as a module inside the above-described printer driver 12. Furthermore, the program stored in a recording medium such as a CD is installed in the host computer 10 or the program is downloaded from the prescribed site via a network such as internet, and then the program is thereby provided in the host computer 10.

The patch sheet data 16 is the print data of the patch sheet P-S that is outputted from the printer 20 during the calibration. This data is recorded on a ROM or a hard disk. The patch sheet data 16 is data having a gradation value of each color for each-pixel and is here composed, for example, of gradation values (0-255) of C (Cyan), M (Magenta), Y (Yellow), and K (Black), which are the colors of a coloring material (toner or ink) used by the printer 20.

Furthermore, in addition to the patch pattern data that is outputted to the patch sheet P-S and serves as a color measurement object, the patch sheet data 16 includes a dummy pattern (dummy specimen) employed to perform the image formation of the patch pattern in a stable state of a printing engine 24. This is a significant feature of the present invention and will be described below in greater detail with respect to the data and the patch sheet P-S outputted by the data.

The standard data 17 is data indicating the density (color values, for example Lab values, XYZ values) that have to be actually outputted with respect to each gradation value of image data, and this data is recorded in a ROM or a hard disk. Here, for example, the aforementioned gradation values are represented by gradation values of each color of CMYK, and the density (color values) is represented by Lab values. Therefore, for example, L, a, and b values are determined for each gradation value of C. The standard data 17 is compared as a standard value (target value) with the color measurement results of the patch sheet P-S during calibration.

Further, the color correction table 18 is a table containing information for correcting so that the color information of the image data of the printing object at the time of printing request from the above-described printer driver 12 is represented as a density shown by the standard data 17, in other words, so as to obtain the output (printing result) suitable for this color information, according to the density characteristic of the printer 20. Here, it is a table in which the gradation values after correction are associated with the gradation values of each CMYK color of the original image data. In the present embodiment, the results of calibration are reflected in this color correction table 18.

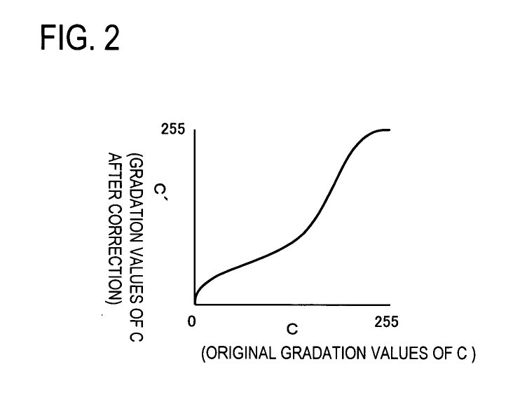

FIG. 2 is a figure illustrating the color correction table 18. In FIG. 2, the color correction table relating to the C color is represented by a graph in which the gradation value (C) of original C is plotted against the abscissa, and the gradation value (C′) of C after the correction is plotted against the ordinate. Furthermore, the curve in the figure represents the relationship between C and C′, and the gradation value of C of the original image data is corrected based on the correspondence shown by this curve. Similar color correction tables are also prepared for each MYK color. The color correction table 18 is stored in a RAM or a hard disk.

Further, the printer 20 is, as described hereinabove, an image forming device of the present embodiment and an object of calibration. A printing system such as an electrophotographic system or an ink jet system is employed in the printer 20, and the contents of the above-mentioned patch sheet data is different in each case. Furthermore, as shown in FIG. 1, the printer 20 is provided with a control unit 22 and a printing engine 24.

The control unit 22 is the so-called controller that performs the prescribed processing of the received printing data to produce data for the printing engine 24 when a printing request is received from the host computer 10, outputs the produced data to the printing engine 24, and issues a printing command. Furthermore, during calibration processing, the controller receives the patch sheet data 16 and executes a similar processing. The control unit 22 comprises a CPU, a RAM, a ROM, an ASCI, etc.

The printing engine 24 is a unit for conducting printing on a printing medium such as a recording paper based on data (signals) supplied from the control unit 22. During calibration processing, the printing engine outputs a patch sheet P-S according to the command from the control unit 22. When the printing system is an electrophotographic system, the printing engine 24 comprises a charging unit, an exposure unit, a development unit, a transfer unit, etc., and a cartridge accommodating CNYK toners is mounted on the development unit. When the printing system is an ink-jet system, the printing engine comprises a head unit equipped with nozzles for discharging CMYK inks and a carriage that carries the head unit and moves it in the main scanning direction.

The outputted patch sheet P-S is a sheet obtained by outputting a plurality of patch patterns by changing the gradation values of image data for each color of the coloring materials (toners or inks) used in the printer 20. In the patch sheet P-S of the present embodiment, a dummy pattern is outputted in addition to the aforementioned patch patterns and this is an important feature of the present invention.

Further, the color measurement device 30 is a device such as a scanner for reading the color values of patch patterns on the patch sheet P-S when the printer 20 is calibrated. As described hereinabove, the color measurement device is connected to the host computer 10 with a cable and controlled by the calibrator 14. During the calibration processing, the patch sheet P-S disposed by the user is read and the color measurement results (RGB multiple gradation values, Lab values, etc.) are supplied to the calibrator 14.

A specific processing procedure in each device of the present embodiment having the above-described configuration will be described below.

First, an example of processing performed during usual printing with the printer 20 will be explained. If the printer driver 12 receives a printing request from an application (not shown in the figure) of a printing request source in the host computer 10, the printer driver 12 first performs a conversion from the data format in which the image data of the printing object were received to an intermediate code. Then, the intermediate code is subjected to expansion processing and converted into data (RGB data) composed of R (red) G (green) B (blue) gradation values of each pixel. The RGB data is then color converted into data of CMYK (CMYK data) used in the printer 20. The CMYK are then corrected based on the above-described color correction table 18, and the corrected data (C′M′Y′K′ data) are compressed and transmitted to the printer 20.

The control unit 22 of the printer 20 stores the received data, reads the stored data at the predetermined timing, subjects the data to processing such as decompression, and then transmits the data to the printing engine 24. Image formation on a printing medium is executed in the printing engine 24 based on the transmitted signals.

When the printing system is an electrophotographic system, a photosensitive drum is irradiated with a laser beam via a polygon mirror based on the transmitted signals for each color and an electrostatic latent image is formed. Then, a development unit of the corresponding color conducts the development by causing a toner to adhere to the latent image and an image is formed by transferring to the printing medium. If a tandem device is employed, the exposure unit, photosensitive drum, and development unit are provided for four colors of CMYK and the processing of all colors is executed in parallel. On the other hand, in the so-called four-cycle laser printers, one exposure unit and photosensitive drum are provided and the processing of each color is executed sequentially.

When the printing system is an ink jet system, inks of each color are ejected and an image is formed on the recording medium based on the transmitted signal, while moving the head unit in the main scanning direction over the printing medium. The entire image is formed by repeatedly executing the processing in combination with the movement of the printing medium in the sub-scanning direction.

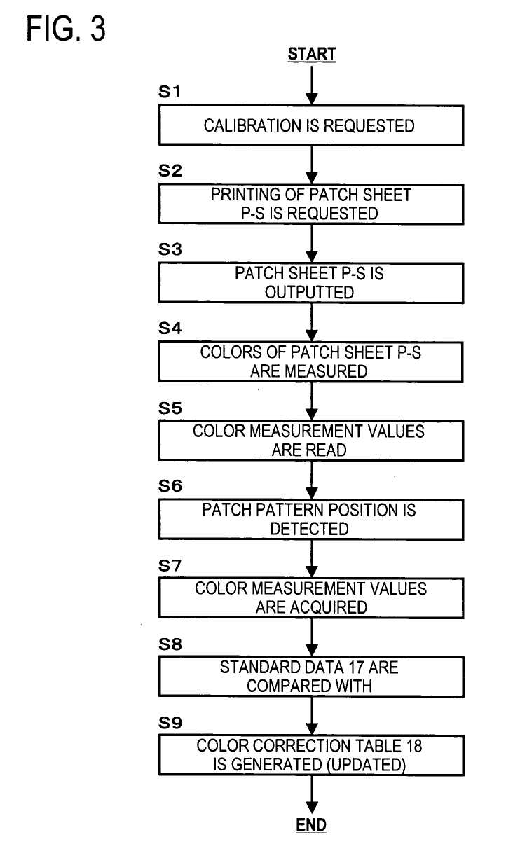

A processing procedure employed when conducting the calibration of output density in the printer 20 will be described below. FIG. 3 is a flowchart illustrating an example of processing procedure during calibration. First, the user issues a calibration execution request to the calibrator 14 of the host computer 10 (step S1). Upon receiving the request, the calibrator 14 reads out the above-described patch sheet data 16, transmits them to the printer 20, and issues a printing request for a patch sheet P-S (step S2). The printer 20 receives the patch sheet data 16, executes the processing similar to that executed during the above-described usual printing, and outputs a patch sheet P-S (step S3)

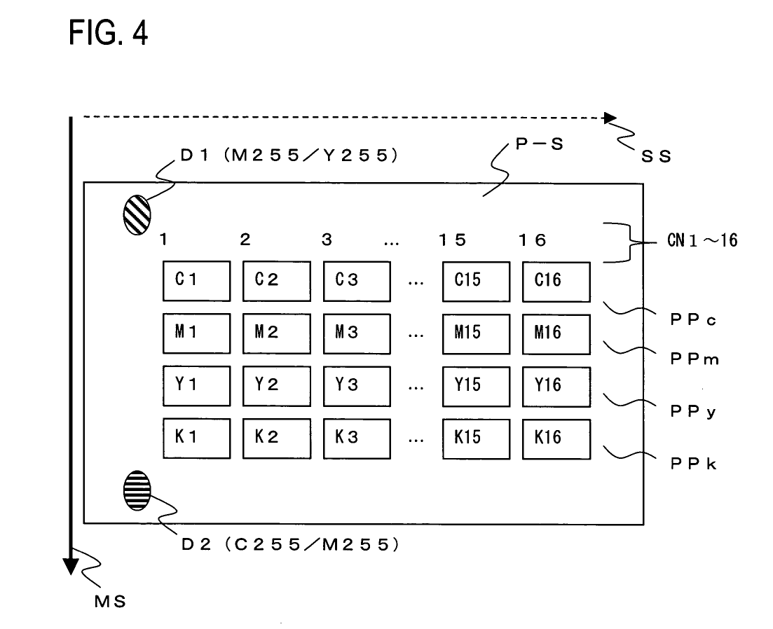

FIG. 4 shows an example of the patch sheet P-S. This example relates to the case where the printing system is an electrophotographic system, more particularly to the case of a tandem device in which processing of the colors is conducted in parallel. The patch sheet P-S includes a plurality of patch patterns (rectangles shown in the figure) in which the gradation value for each color changes from a minimum value to a maximum value for a plurality of toner colors (here, CMYK) used by the printing engine 24. Those patch patterns serve as an image specimen for calibration and are the color measurement objects of the color measurement device 30. In FIG. 4, MS indicates the main scanning direction, and SS indicates the sub-scanning direction.

In the example shown herein, there are patch patterns PPc, PPm, PPy, and PPk for the steps obtained by dividing by 16 the gradation values 0-255 for 8 bit of each color with respect to four colors: C (cyan), M (magenta), Y (yellow), and K (black). The patch pattern PPc comprises patches Cn (n=1, 2, . . . , 16) for the steps obtained by divining the gradation value range of C (cyan) by 16 and is set so that the gradation value of patch Cn becomes 16×n−1. Similarly, the patch pattern PPm (patches M1-M16), is arranged for M (magenta), the patch pattern PPy (patches Y1-Y16) is arranged for Y (yellow), and the patch pattern PPk (patches K1-K16) is arranged for K (black). Furthermore, the gradation value variation of the patch pattern by the above-described division by 16 is merely an example and other variation modes are also possible. Furthermore, the variation does not necessarily have the same width.

Dummy patterns D1, D2 and CN1-16 are outputted to the patch sheet P-S. The color of the dummy pattern D1 is “red color” obtained by color mixing of M and Y at respective 255 gradation values. The color of the dummy pattern D2 is “blue color” obtained by color mixing of C and M at respective 255 gradation values. Furthermore, CN1-16 are numerals of “1”-“16” indicating the grade of the gradation values of the patch pattern PP divided by 16 and outputted in K (black). Those dummy patterns are arranged in a position in which any dummy pattern is processed prior to the patch pattern PP in the above-described printing processing of each color. The outputting procedure of the patch sheet P-S including those dummy patterns and effect of dummy patterns will be described below.

Thus, the present patch sheet P-S has dummy patterns arranged on the periphery of the patch pattern PP in addition to the patch pattern PP, and the above-described patch pattern data 16 is the printing data for which such patch sheet P-S is outputted.

On the other hand, in the host computer 10, the calibrator 14 displays a message that the outputted patch sheet P-S has to be loaded in the color measurement device 30 and color measurements have to be conducted. In response to this message, the user arranges the patch sheet P-S in the prescribed position of the color measurement device 30 and instructs the device to execute color measurements. In response to this command, the color measurement device 30 conducts color measurements of the patch sheet P-S (step S4).

The calibrator 14 then reads the color measurement results (step S5) and performs the detection of the patch pattern position (step S6). Thus, the calibrator determines a patch pattern corresponding to each color measurement value obtained with the color measurement device 30. Then, the calibrator 14 acquires the color measurement values of each patch pattern of each color based on the detected patch pattern position (step S7). When the color measurement device 30 is a scanner, the color measurement values are obtained as RGB values of each pixel. Therefore, for example, an averaging processing of those values is conducted and one measurement value (color measurement value) is acquired for each patch pattern based on RGB values of each pixel positioned in the position of each detected patch pattern, that is, in the region of each detected patch pattern.

Then, the calibrator 14 compares the acquired color measurement value and the above-described standard data 17 (step S8). More specifically, first, a correspondence relationship between the original gradation values of each patch pattern, that is, the gradation values in the patch sheet data 16, and the color measurement values is created for each color. When the color measurement device 30 is a scanner, the color measurement values are represented as RGB values. Therefore, this correspondence relationship is created after the conversion to Lab values. Because the patch pattern is generated, as described hereinabove, with respect to the gradation value with the predetermined spacing, the correspondence relationship of the gradation values and color measurement values represents sporadic data, but the data can be made denser by interpolation of the gaps between the data. This interpolation may be performed when the below-described color correction table is generated. The calibrator 14 then compares the created correspondence relationship and the standard data 17, which are data of the same format.

The calibrator 14 recognizes the difference between the two based on the comparison results and generates the aforementioned color correction table 18 such that printing is conducted at a target value indicated in the standard data 17 with respect to each gradation value of each color (step S9). This table is used to replace the color correction table 18 that has been heretofore used. When there is the above-described difference between the color measurement values acquired from the patch sheet P-S and the standard data 17, the gradation values of the original image data have to be converted into gradation values that will output the standard data values corresponding to the gradation values prior to conducting processing in the printing engine 24 of the printer 20, and this role is played by the color correction table 18. The gradation values after the conversion are determined based on the detected difference.

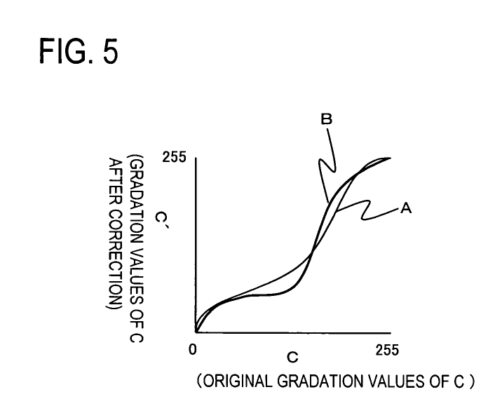

FIG. 5 illustrates the update of the color correction table 18. In FIG. 5, similarly to FIG. 2, the color correction table 18 relating to the C color is represented by a graph where the gradation value (C) of the original C is plotted against the abscissa and the gradation value (C′) of the C after the correction (conversion) is plotted against the ordinate. The curve A in the figure shows the relationship between C and C′ relating to the original color correction table 18, and the curve B shows the relationship between C and C′ relating to the updated color correction table 18.

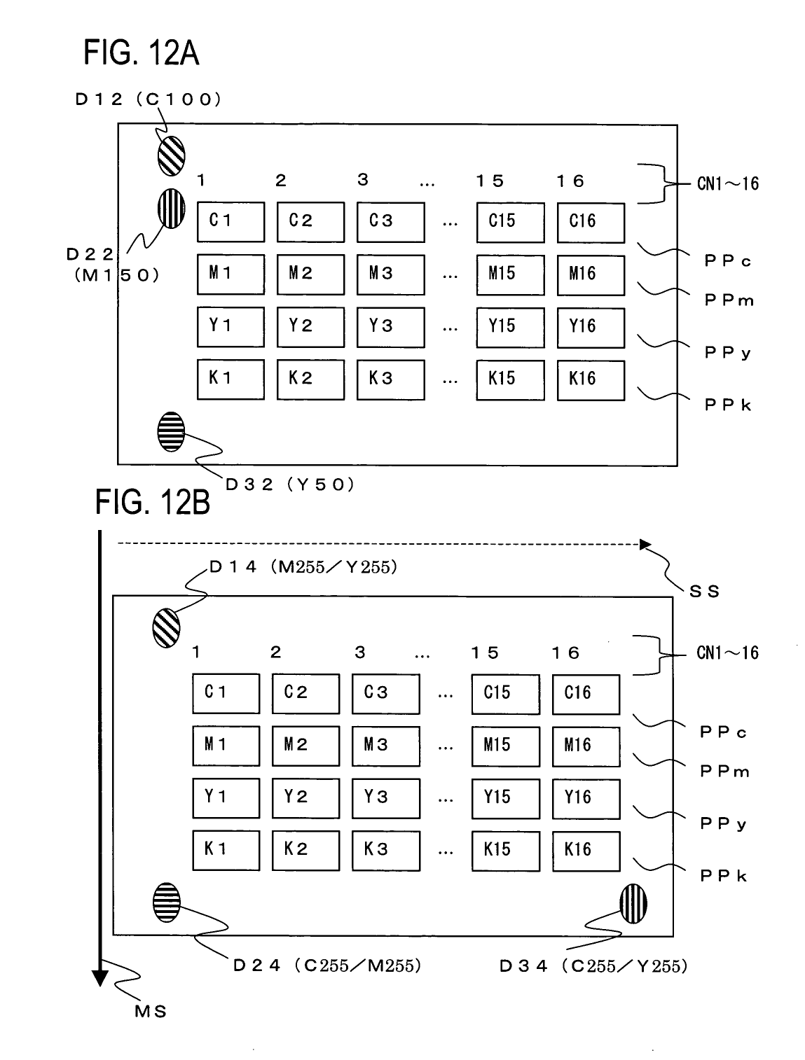

The calibration process is completed by generating a new color correction table 18 in the above-described manner and storing it in the predetermined location. During subsequent printing, the generated color correction table 18 will be used for the above-described color correction (CMYK data→C′M′Y′K′ data) (in the example shown in FIG. 12, the curve B is used) and printing will be conducted appropriately at the standard values till the density characteristic of the printer 20 changes.

In the present embodiment, the color correction processing for correcting the gradation values of the original image so as to be output at an appropriate density prior to executing printing is conducted with respect to data after the expansion of CMYK, which are the colors used in the printer 20, but this timing for conducting the color correction processing is not limiting, and the color correction processing may be also conducted with respect to RGB data prior to the above-described color conversion processing, or in combination of the color conversion processing (RGB data→CMYK data). Therefore, in those cases, the calibration results, that is, the relationship of the gradation values and color measurement values, the difference with the standard data 17, and the gradation values after conversion are reflected in a format fit for the respective color conversion processing.

Furthermore, in the present embodiment, the color correction table 18 was present in the host computer 10, but it may be provided in a printer 20, for example, in a storage device located in the control unit 22. In this case, the printer driver 12 of the host computer 10 will transmit the CMYK data prior to color correction and the color correction processing will be conducted in the control unit 22 of the printer 20. In this case, too, the calibration processing centered on the calibrator 14 will be conducted in a similar manner.

The patch sheet data 16 and standard data 17 also may be contained in the control unit 22 of the printer 20.

The printer 20 is calibrated in the above-described manner, but as described hereinabove, the patch sheet P-S used for the calibration and the printing data 16 thereof have specific features. Accordingly, the image forming procedure of the patch sheet P-S and the effect thereof will be explained below.

First, the case will be explained in which the patch sheet P-S shown in FIG. 4 is outputted. As described hereinabove, this patch sheet P-S relates to the case of a tandem device with an electrophotographic printing system. Therefore, in this case, an exposure unit (including a polygon mirror) and a photosensitive drum are provided for each color of CMYK. Furthermore, the polygon mirrors for each color have to reach a respective sufficient temperature in order to form a latent image on the photosensitive drum in a stable state.

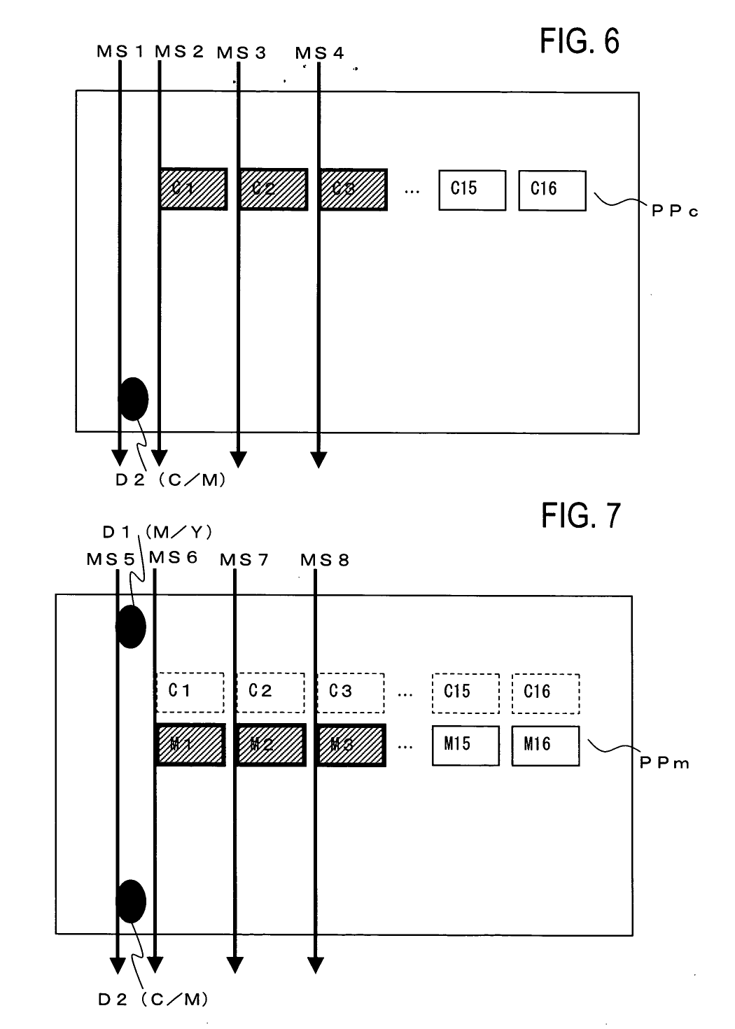

FIG. 6 is an explanatory drawing illustrating a state where the patch pattern PPc is scanned. When the output command of the patch sheet P-S shown in FIG. 4 is outputted, in the unit of the printing engine 24 relating to C (cyan), the image formation is conducted with respect to the portion (dummy pattern D2 and patch pattern PPc) of the patch sheet P-S shown in FIG. 6.

If we assume that the exposure by the laser beam in the main scanning direction MS and the movement of the main scanning position that is based on the movement (rotation) of the photosensitive drum in the sub-scanning direction SS shown in FIG. 4 is respectively performed, then a latent image will be first formed on the photosensitive drum with respect to a dummy pattern D2, which is a “blue color” produced by mixing C (cyan) and M (magenta) and contains C (cyan), and then the latent images will be sequentially formed with respect to patch patterns of C1, C2, C3, . . . . The reference symbol MS1 in FIG. 6 denotes the initial scanning line relating to the dummy pattern D2. After a plurality of scanning cycles are then performed, the scanning of C1 is started from the position shown in MS2, and if C1 ends, the scanning of C2 is started from the position shown in MS3.

Thus, in the unit relating to C (cyan), the latent image relating to the dummy pattern D2 is formed prior to forming the latent image relating to the patch pattern PPc, which is the color measurement object in calibration. Therefore, in the process of forming the latent image of the dummy pattern D2, the temperature of the polygon mirror of the unit relating to C (cyan) reaches the sufficient level and the latent image of the patch pattern PPc is formed in a state where the polygon mirror has been heated once and the printing engine 24 assumed a more stable state. Therefore, the patch pattern PPc reflecting the density characteristic of the printing engine 24 at this point in time can be outputted.

Within the framework of the conventional technology, such adequate dummy pattern D2 is not present and the patch C1 is the first to be scanned. Therefore, with respect to C1, the latent image is formed in a state where the polygon mirror has not yet reached the sufficient temperature, and the patch pattern reflecting the density characteristic of the printing engine 24 at this point in time cannot be obtained.

FIG. 7 is an explanatory drawing illustrating a state where the patch pattern PPm is scanned. FIG. 7, similarly to FIG. 6, illustrates a portion (dummy patterns D1, D2 and patch pattern PPm) formed by the unit of the printing engine 24 relating to M (magenta). In this case, too, the initial scanning position of the dummy patterns D1, D2 is shown by MS5, the initial scanning positions of patches M1, M2, M3 are shown by MS6, MS7, MS8, respectively, and the formation of latent images on the photosensitive drum is conducted in a sequence of D1, D2, M1, M2, M3, . . . .

Therefore, in the unit relating to M (magenta), a latent image for the dummy pattern is also formed before the formation of a latent image relating to the patch pattern PPm, the polygon mirror of the unit relating to M (magenta) reaches a sufficient temperature during the formation of the latent image of the dummy pattern, and the formation of the latent image for the patch pattern PPm is conducted after the printing engine 24 assumes a more stable state. Therefore, the patch pattern PPm reflecting the density characteristic of the printing engine 24 can be outputted.

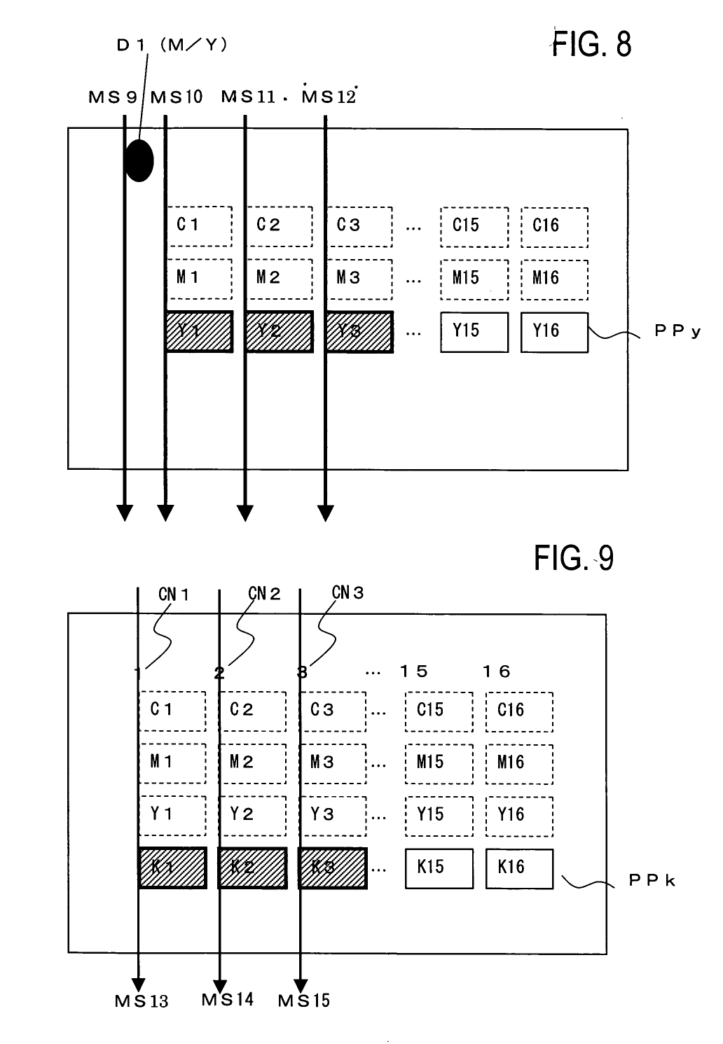

FIG. 8 is an explanatory drawing illustrating a state where the patch pattern PPy is scanned. FIG. 8, similarly to FIG. 6 and FIG. 7, illustrates a portion (dummy pattern D1 and patch pattern PPy) formed by the unit of the printing engine 24 relating to Y (yellow). In this case, too, the initial scanning position of the dummy pattern D1 is shown as MS9, the initial scanning positions of patches Y1, Y2, Y3 are shown by MS10, MS11, MS12, respectively, and the formation of latent images on the photosensitive drum is conducted in a sequence of D1, Y1, Y2, Y3 . . . .

Therefore, in the unit relating to Y (yellow), a latent image for the dummy pattern is also formed before the formation of a latent image relating to the patch pattern PPy, the polygon mirror of the unit relating to Y (yellow) reaches a sufficient temperature during the formation of the latent image of the dummy pattern, and the formation of the latent image for the patch pattern PPy is conducted after the printing engine 24 assumes a more stable state. Therefore, the patch pattern PPy reflecting the density characteristic of the printing engine 24 can be outputted.

FIG. 9 is an explanatory drawing illustrating a state where the patch pattern PPk is scanned. FIG. 9, similarly to FIGS. 6 to 8, illustrates a portion (CN1-16 and patch pattern PPk) formed by the unit of the printing engine 24 relating to K (black). In this case, the initial scanning positions of patches K1, K2, K3 are also shown by MS13, MS14, MS15, respectively.

Here, focusing attention on the position of “1” of CN1, one can notice that this position is shifted from the patch K1 to the left in the sub-scanning direction SS and located above the patch K1 in the main scanning direction MS. Therefore, the formation of the latent image of CN1 “1” will start at a scanning line on the left side from the initial scanning line MS13 relating to the patch K1. Therefore, the latent image formation will be started before any patch K1-K16. Furthermore, even if the formation of the latent image of CN1 “1” is started at the scanning line MS13, the latent image is formed before the patch K1 in the scanning of this scanning line. Therefore, in this case, the formation of the latent image of CN1 “1” is conducted before the patch pattern PPk.

Therefore, in the unit relating to K (black), a latent image for CN1 “1” functioning as a dummy pattern is also formed before the formation of a latent image relating to the patch pattern PPk, the polygon mirror of the unit relating to K (black) reaches a sufficient temperature during the formation of this latent image, and the formation of the latent image for the patch pattern PPk is conducted after the printing engine 24 assumes a more stable state. Therefore, the patch pattern PPk reflecting the density characteristic of the printing engine 24 can be outputted.

CN1-16 function as dummy patterns for stabilizing the state of the printing engine 24, but at the same time they can be outputted to the patch sheet P-S and used to show the stage of gradation values of each patch to the user. Thus the coloring material relating to the dummy pattern can be used effectively by employing the dummy pattern to indicate any information relating to the patch sheet P-S and patch pattern PP to the user.

Furthermore, a dummy pattern comprising K (black) instead of the sequence number CNn may be also provided in a position where it is scanned before the patch pattern PPk.

As described hereinabove, first a latent image of a dummy pattern is formed and then latent images of patch patterns are formed on each photosensitive drum of each color by the patch sheet P-S shown in FIG. 4 and the printing data 16 thereof. Therefore, stable latent images of patch patterns can be formed on all the photosensitive drums, and the patch sheet P-S of the patch patterns accurately reflecting the output density characteristic of the printing engine 24 can be outputted. As a result, the above-described calibration based on the patch sheet P-S is conducted more accurately.

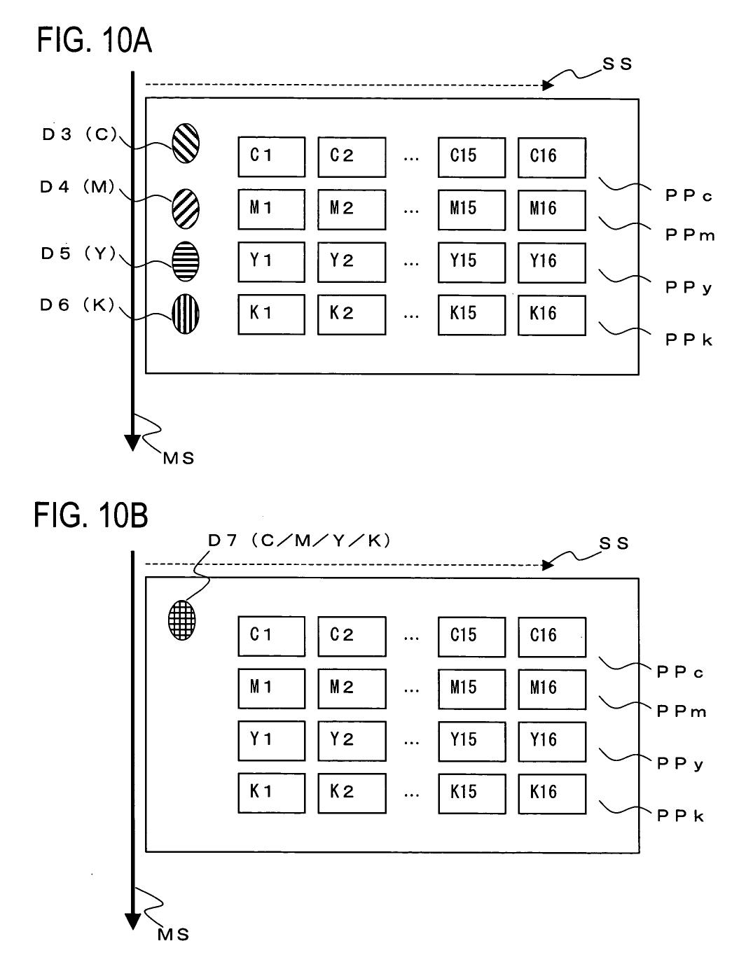

Possible alternative examples will be described below. FIG. 10 is an explanatory drawing illustrating another example of the patch sheet data 16. This example also relates to the case of a tandem device with an electrophotographic printing system. In FIG. 10, the patch sheet data 16 are shown as images formed on a photosensitive drum or printing medium based on the patch sheet data 16.

In the example shown in FIG. 10A, monochromatic dummy patterns D3 (C (cyan)), D4 (M (magenta)), D5 (Y (yellow)), D6 (K (black)) are present instead of the dummy patterns of mixed colors such as the above-described dummy patterns D1, D2. In FIG. 10B, only a dummy pattern D4 of a mixed color of all the colors C, M, Y, K is shown.

In the cases illustrated by FIGS. 10A, 10B, when the laser beam of the printing engine 24 is scanned along the main scanning direction MS and the scanning line is moved along the sub-scanning direction SS to draw the entire image, the dummy patterns are also formed prior to patch patterns PPc, PPm, PPy, or PPk.

Therefore, in those examples, at the point in time the patch C1, M1, Y1, or K1 is scanned, the polygon mirror is also heated and the printing engine 24 assumes a more stable state. Therefore, the patch pattern PP reflecting the density characteristic of the printing engine 24 can be outputted. Outside the scope of those example, the same effect can be also obtained if the patch pattern data 16 are such that the dummy pattern where all the colors of CMYK are contained assumes a position in which it is scanned before the patch pattern PP.

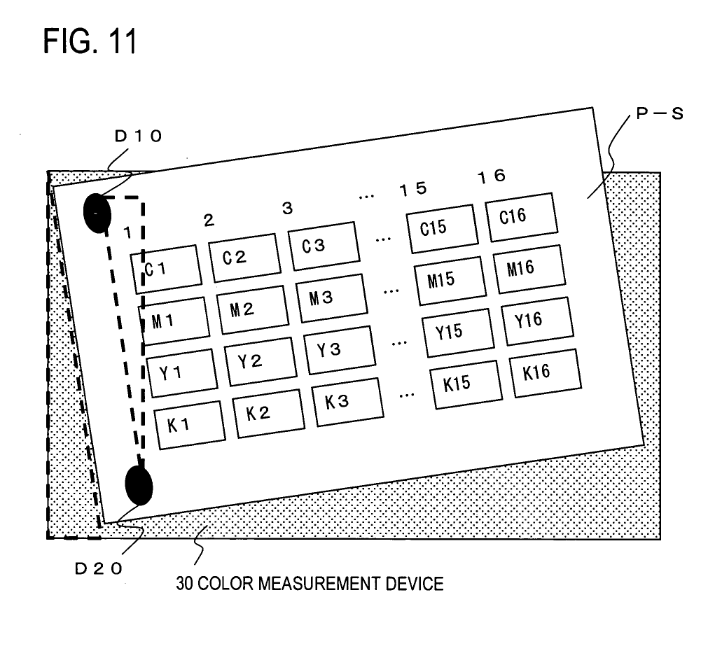

FIG. 11 is an explanatory drawing illustrating the case where the dummy pattern is also used as a marker pattern for detecting the position of the patch pattern. As described hereinabove, the patch patterns of the patch sheet P-S that was outputted based on the patch sheet data 16 is read by the color measurement device 30, and the data on the color measurement values that were read out (for example, RGB multigradation value data) are supplied to the calibrator 14. When the calibrator 14 acquires the color measurement values (color values) of each patch pattern, it acquires the color measurement values (color values) in association with the (original) gradation values of the patch pattern. Therefore, the position of the patch pattern has to be detected accurately.

The example shown in FIG. 11 relates to the case in which color measurements are conducted by arranging a patch sheet P-S identical to the patch sheet P-S shown in FIG. 4 in a position inclined with respect to the predetermined position (a rectangle on the rear surface in the figure) of the color measurement device 30. In this case, the dummy patterns D10 and D20 (equivalent to D1 and D2 in FIG. 4) that were used to stabilize the state of the printing engine 24 are used to detect the position of the patch pattern. More specifically, as shown by a dot line in the figure, the degree of inclination of the data read out with the color measurement device 30 is recognized by computations based on the position of the dummy patterns D10, D20, and the accurate position of the patch pattern can be detected based on such recognition.

Thus, employing a dummy pattern also as a marker patch makes it possible to use effectively the coloring material for the dummy pattern and make additional contribution to increasing the accuracy of calibration.

FIG. 12 is an explanatory drawing illustrating an example in which the color or gradation value of the dummy pattern is different from those of all the patch patterns. When the dummy pattern is used as a marker patch, as in the above-described example, if the dummy pattern is assumed to have a color and gradation value identical to those of any of the patch patterns, then the dummy pattern and patch pattern are difficult to discriminate one from another. For this reason, in the example shown in FIG. 12 the color or gradation value of the dummy pattern is assumed to be different from that of the patch pattern.

FIG. 12A illustrates the case where the dummy patterns and patch patterns have the same color and different gradation values. In this example, a dummy pattern D12 has a “100” gradation value of C (cyan), a dummy pattern D22 has a “150” gradation value of M (magenta), a dummy pattern D32 has a “50” gradation value of Y (yellow), and none of the dummy patterns has a gradation value identical to those of the patch patterns. Therefore, in this case, the dummy patterns can be easily distinguished from the patch patterns and are more suitable as marker patterns for position detection of patch patterns.

On the other hand, in the example shown in FIG. 12B, the dummy patterns and patch patterns have different colors and the same gradation values. In this example, a dummy pattern D14 has a mixed color of a “255” gradation of magenta and a “255” gradation of yellow, a dummy pattern D24 has a mixed color of a “255” gradation of cyan and a “255” gradation of magenta, and a dummy pattern D34 has a mixed color of a “255” gradation of cyan and a “255” gradation of yellow. In this case, the dummy patterns can be also easily distinguished from the patch pattern because they have different colors and the dummy patterns are, therefore, more suitable as marker patterns for position detection of patch patterns.

Placing the dummy pattern D34 in the lower right corner of the patch sheet P-S contributes to the functioning of this dummy pattern as a marker pattern for detecting the position of patch pattern. This is because the position of the patch pattern can be detected based on the mutual arrangement with D34, rather than based only on the mutual arrangement with dummy pattern D14 or D24. For example, when the up and down of the patch sheet P-S are inverted with respect to the color measurement device 30, the dummy patterns D14, D24 are not present in the predetermined positions, but instead the position of the dummy pattern D34 can be initially determined. Therefore, the calibrator 14 can rapidly detect the position of the patch pattern PP from the position of D34.

In an example shown in FIG. 4, which is outside the scope of the above-described alternative example, CN1-16 may be outputted with all the colors of CMYK and dummy patterns D1 and D2 may be eliminated. In this case, a latent image relating to CN1 “1” is also formed before the patch pattern PP in the latent image formation of each color and a similar effect can be obtained.

The patch sheet P-S explained hereinabove and the patch sheet data 16 therefor can be also used in a four-cycle device with an electrophotographic printing system in which the formation of latent images of each color is conducted successively by using one photosensitive drum. In such four-cycle device, because the same polygon mirror is used for each color, the dummy pattern for causing the temperature of the polygon mirror to attain the prescribed temperature may be a dummy pattern whose latent image is formed before the formation of a latent image relating to the color (the first color to be processed, for example, C (cyan)) for which a latent image is first to be formed. In other words, a dummy pattern may be provided which has a color that is first to be processed and arranged in a position where the latent image will be formed before the patch pattern of this color. For example, when C (cyan) is the first color to be processed, only D12 can be provided as a dummy pattern in the example shown in FIG. 12A. As a result, when the patch sheet P-S is outputted, first, a latent image is formed for the dummy pattern D12, the polygon mirror temperature reaches the predetermined temperature, and then stable latent images are formed successively from the patch pattern PPc.

Furthermore, in the patch sheet data 16 for an electrophotographic system that was explained hereinabove, the case was explained where the dummy pattern was outputted to the patch sheet P-S, but it is also possible not to output the dummy pattern to the patch sheet P-S (recording paper). More specifically, in such case, the dummy pattern is processed as far as the formation of a latent image on a photosensitive drum, and subsequent processing is not conducted.

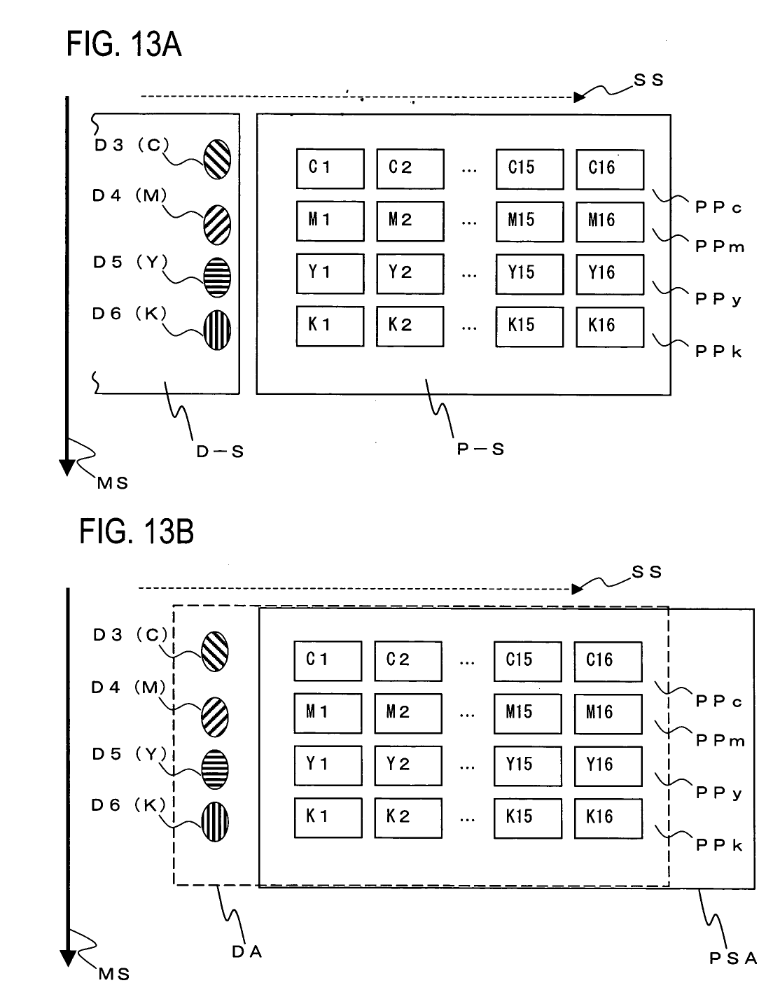

FIG. 13 illustrates such an alternative example, FIG. 13 shows an example using the same data as the patch sheet data 16 of the example shown in FIG. 10A. In the case shown in FIG. 13A, the first sheet (D-S) of the printing medium (recording paper) serves for a dummy pattern D3-D6 portion of the patch sheet data 16, and the second sheet (P-S) of the printing medium serves for the patch pattern PPc-PPk. In this case, the processing of the first sheet (D-S) is conducted up to the formation of a latent image on the photosensitive drum and the processing is ended without conducting subsequent processing such as development, transfer, and output. Immediately thereafter, a transition is made to the processing of forming a latent image of the second sheet (P-S); with respect to the second sheet, the processing is conducted in the usual manner up to the output onto a printing medium and a patch sheet P-S is outputted. The polygon mirrors for each color have thus already been heated when the formation of the latent image of the second sheet (P-S) is performed. Therefore, the formation of latent image on the second sheet is conducted in a stable state and the first sheet (D-S) is not developed. Therefore, the coloring material (in this case, a toner) is not wasted.

FIG. 13B illustrates a case where the processing range (position of the recording paper) is shifted with respect to development and subsequent processing, so that the dummy pattern D3-D6 portion of the patch sheet data 16 is not outputted onto the recording paper. In this case, the formation of latent images is conducted for the entire range (DA) shown by a broken line in the figure, but with respect to the development and subsequent processing, the position of the page is shifted in the sub-scanning direction SS and the processing is conducted with respect to the range (PSA) shown by a solid line in the figures. As a result, similarly to the above-described case illustrated by FIG. 13A, the effect of forming the latent image of the patch pattern PP in a stable state can be obtained. At the same time, the consumption of the coloring material (in this case, a toner) on the dummy pattern can be inhibited.

In the four-cycle device, the same effect can be also obtained, for example, by using only the dummy pattern D3 in the patch sheet data 16 shown in FIG. 13.

Furthermore, as another embodiment of the electrophotographic configuration, each patch sheet data 16 explained hereinabove is used in a device in which the color values of each patch are measured after the patch patterns have been developed on a photosensitive body, and the calibration is conducted based on the measurement results. In this case, a similar effect can be also obtained because the latent image of the patch pattern PP was formed in a stable state for the same reasons as described above. Furthermore, in this case, though a sensor for color measurement has to be provided in the printer 20 and the results of color measurements on the photosensitive body have to be converted into color values on the recording paper, the consumption of recording paper can be inhibited because the patch sheet P-S is not outputted. Moreover, as was explained based on FIG. 13, it is also possible to conduct no development with respect to the dummy pattern portion.

In addition, one of the features in each patch sheet data 16 explained hereinabove is that the dummy pattern is apart from the patch pattern. In the case that a printer is in a state where printing colors are much different from intended colors, colors of a dummy pattern and a patch pattern in an outputted patch sheet might be out of the range in which a calibrator can detect colors. In this case, it might be difficult to perform the detection of patch pattern position based on the measured color values, corresponding to the processing in the step S6 of FIG. 3. However, in the above-mentioned embodiments of the present invention, there is a part, which has an original sheet color (for example, white) and on which the laser beam does not scan, between the dummy pattern and the patch pattern PP on the patch sheet P-S, and the dummy pattern is apart from the patch pattern PP. Thus, if the measured color values are out of the range in which the calibrator 14 can detect colors, it is easy for the calibrator 14 to detect the patch pattern position because the calibrator 14 can recognize the dummy pattern from the patch pattern PP.

The patch sheet data 16 and patch sheet P-S relating to the case where the printing system in the printer 20 is an ink-jet system will be explained below.

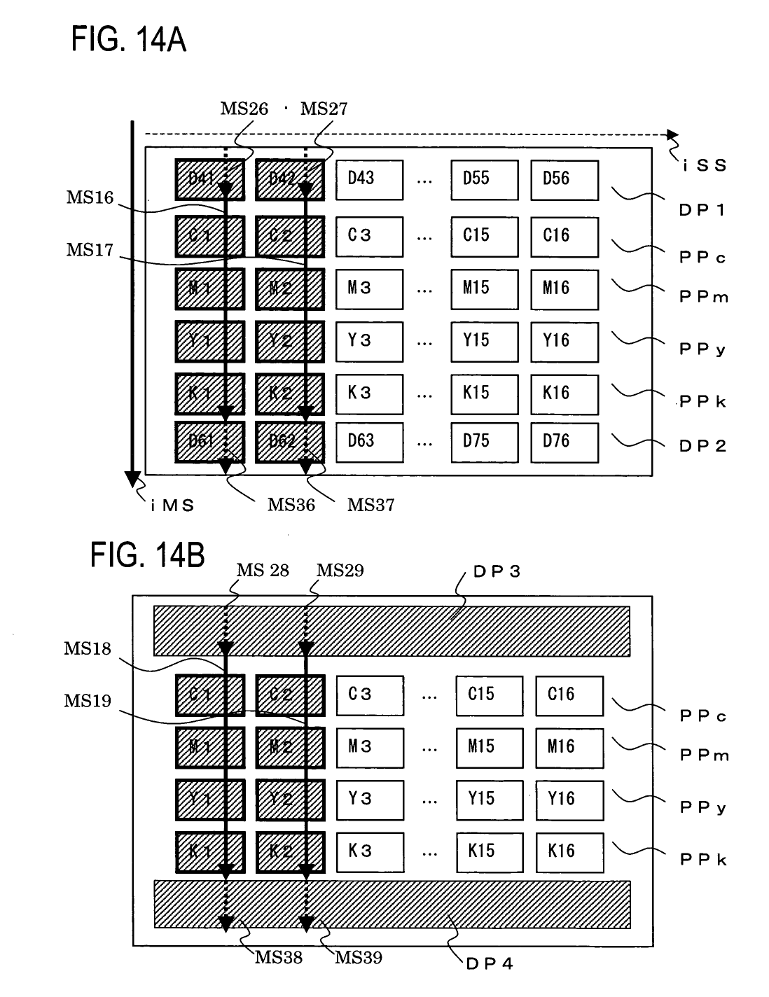

FIG. 14 is an explanatory drawing for illustrating the patch sheet data 16 in the case of an ink-jet system. FIG. 14 shows a state in which the dummy pattern and patch pattern PP based on the patch sheet data 16 are outputted onto a printing medium (recording paper) and a patch sheet P-S is formed.

In the examples shown in FIG. 14A, in addition to the data of patch pattern PP, the patch sheet data 16 has data of dummy patterns D41-D56 located in positions that are scanned (an image is formed) before the patch pattern PP along the main scanning direction of the head unit and the dummy patterns D61-D76 located in positions that are scanned (an image is formed) after the patch pattern PP, those dummy patterns having any color of the coloring material (in this case, an ink) used for printing.

When image formation is conducted with such data, ink is ejected, while the head unit moves along the main scanning direction iMS, and the entire image is formed by relative scanning with the head unit in the sub-scanning direction iSS by moving the recording medium, and the movement of the head unit in one scan is a DP1-DP2 range where an image is present in the main scanning direction iMS. For example, in one scan in the main scanning lines MS26, 16, 36, the head unit moves from the upper end of D41 to the lower end of D61.

Therefore, in this scanning, a segment in which the head unit accelerates to reach the prescribed speed during image formation is the range of the dummy pattern D41 (MS26), whereas the deceleration range from this prescribed speed to a stop is the range of the dummy pattern D61 (MS36). As a result, in this case, at the time of image formation (MS16) of the patch patterns PPc-PPk serving as color measurement objects of calibration, the head unit assumes a state with a constant speed equal to the prescribed speed, the patch patterns PPc-PPk can be formed in a stable state and each patch can be formed with a uniform density. The same is true for other main scanning lines such as main scanning lines MS27, 17, 37, and using the above-described patch sheet data 16 makes it possible to form the patch patterns PPc-PPk in a stable state and to output a patch sheet P-S accurately reflecting the characteristics of the printer 20.

With the conventional method, DP1 and DP2 are not present. Therefore, the above-described acceleration segment and deceleration segment are within patch pattern ranges (in the example shown in FIG. 14, within ranges of PPc, PPk), and the portions matching those segments have nonuniform amounts of adhered ink.

By color mixing individual dummy patterns D41, D42, . . . D56, and D61, D62, . . . D76 constituting dummy patterns DP1 and DP2 with any combination of all the CMYK, they can be easily distinguished from the patch pattern PP. Therefore, the dummy pattern can be also used as a marker pattern for detecting the position of the patch pattern.

Further, in the example shown in FIG. 14B, in addition to the data of the patch pattern PP, the patch pattern data 16 has data of dummy patterns DP3, DP4 arranged as band patterns to be scanned before and after the head unit scans the patch pattern PP.

In this case, the dummy patterns DP3 and DP4 also function as the above-described acceleration segment and deceleration segment. For example, in the main scanning lines MS28, 18, 38, the head unit accelerates in the DP3 range (MS28) and the head unit decelerates in the DP4 range (MS38). The same is true for the main scanning lines MS29, 19, 39 in the figure. Therefore, in this case, the dummy pattern will be also reliably included in the scanning range of the head unit and the effect similar to that obtained in the case shown in FIG. 14A will be obtained.

Furthermore, in this case, because the dummy patterns DP3, DP4 are present uninterruptedly in the sub-scanning direction iSS, the above-described movement of the printing medium in the sub-scanning direction iSS is performed with the same movement amount in each cycle. In the example shown in FIG. 14A, because no image is present between the patch rows, for example, between the patch rows from D41 to D61 and patch rows between D42 and D62, when the image is formed, the movement of the printing medium in the sub-scanning direction iSS is performed with a jump over the range where no image is present. Therefore, in this case the movement amount of the printing medium changes intermittently. Such change in the movement amount was empirically demonstrated to cause nonuniform ink discharge. In the example shown in FIG. 14B, in this aspect, too, the change in the movement amount is eliminated and a more uniform ink discharge is possible.

Another specific feature is that the dummy patterns DP3, DP4 extend beyond the range of the patch pattern PP in the sub-scanning direction iSS (left-right direction thereof). Usually, in the initial and last portions (left end and right end in the figure) of one page of the printing medium in the sub-scanning direction iSS, the feed amount (movement amount) in the sub-scanning direction iSS is larger than in the portions where an image is present. Therefore, when the patch patterns PP such as C1-K1 and C16-K16 are present at the left end and right end in the sub-scanning direction iSS in the image (printing range) of the patch sheet P-S, the above-described change in the movement amount of the printing medium can cause a nonuniform ink discharge in these patch patterns PP. However, in the patch sheet data 16, the C1-K1 and C16-K16 are not present at the left and right ends and the image is formed in a state in which a constant movement amount has already been attained. Therefore, good uniformity of ink discharge can be also maintained in those portions.

Furthermore, by color mixing the dummy patterns DP3, DP4 by using a combination of CMYK, they can be easily distinguished from the patch pattern and also used as marker patterns for detecting the positions of the patch patterns. Moreover, the dummy patterns are drawn prior to drawing the patch patterns of each color, the patch patterns PP can be drawn in a state where the nozzle of the head unit is stabilized, and the output characteristic of the printer 20 can be reflected more accurately.

In another modification example, the dummy patterns may be in the form of four monochromatic (C, M, Y, K) stripe images extending in the sub-scanning direction iSS. If they are located in the positions where they are scanned before and after the patch pattern, the head unit can be provided, as described hereinabove, with the above-described acceleration segment and deceleration segment. Furthermore, if the gradation value of each stripe is different from that of the patch pattern of the same color, they can be distinguished from the patch pattern and can be also used as marker patterns for detecting the position of the patch pattern. Furthermore, even if the gradation values are the same, the dummy patterns can be distinguished based on the stripe shape thereof from the patch pattern and, therefore, can be used as the marker patterns.

Furthermore, as an example relating to an ink-jet system, the dummy pattern may occupy the entire region outside the patch pattern PP of the patch sheet P-S. As a result, the effect identical to that of the case shown in FIG. 14B can be obtained.

Furthermore, the height of the patch patterns PPc and PPk may be made larger than that of the patch patterns PPm and PPy and the portions with increased height may be used as dummy patterns instead of the dummy patterns DP1 and DP2 relating to the case shown in FIG. 14A. In this case the upper portion of the patch pattern PPc becomes the acceleration segment of the head unit and, therefore, does not serve as the color measurement object of calibration. Also, the lower portion of the patch pattern PPk becomes the deceleration segment of the head unit and, therefore, does not serve as the color measurement object of calibration.

As described hereinabove, in the printer 20 of the present embodiment, a patch pattern in a patch sheet P-S can be formed in a stable state of the printing engine 24 in the case where the printing system is an electrophotographic system or ink-jet system by using the patch sheet data 16 having a dummy pattern corresponding to the printing system used. Therefore, it is possible to output a patch pattern that reflects the density output characteristic of the printing engine 24 more accurately than in prior art and the calibration accuracy of the printer 20 conducted by using such patch pattern can be increased.

Furthermore, by using this dummy pattern also as a marker for detecting the position of the patch pattern by the calibrator 14, the accuracy of calibration can be further increased and even in this case the coloring material for the dummy pattern can be used effectively.

In addition, the dummy pattern can be also used as an indicator for providing information relating to the patch sheet P-S to the user, and the coloring material for the dummy pattern can be used effectively also in this case.

Moreover, in the case of an electrophotographic system, employing an undeveloped latent image of the dummy pattern also makes it possible to limit the consumption of coloring material.

In the printer 20 of the embodiments, four colors CMYK were used for the coloring materials, but the present invention is not limited to the colors used, and six colors including LC (light cyan) and LM (light magenta) in addition to the four colors, seven colors additionally including LK (light black), or eight colors additionally including LLK may be used.

Furthermore, in the present embodiment, the calibrator 14, printer 20 for outputting the patch sheet P-S, and color measurement device 30 for reading the patch sheet P-S are configured as separate devices, but an image forming device that is the object of calibration may be configured to include the functions of all those devices. For example, it can be configured as the so-called all-in-one device combining the functions of a printer, a scanner, and a copier.

The color measurement device 30 can be also replaced with a digital camera.

What is claimed is:

1. An image forming device for forming an image on a printing medium by forming a latent image on a photosensitive body based on printing data, developing said latent image with coloring material, and transferring said developed image onto said printing medium, wherein
when density calibration of an image formed on said printing medium is conducted, said developed image of an image specimen is formed on said photosensitive body or said image of said image specimen is formed on said printing medium based on said printing data for said calibration,
color of said formed developed image of the image specimen or said formed image of the image specimen is measured and said image density is adjusted based on said color measurement result, and
said printing data for the calibration have data of said image specimen serving as an object of said color measurement and data of a dummy specimen whose said latent image is formed before said latent image of said image specimen is formed.

2. The image forming device according to claim 1, wherein said photosensitive body is provided in a plurality, and said data of the dummy specimen are data for forming said latent image of the dummy specimen before said latent image of the image specimen on each photosensitive body.

3. The image forming device according to claim 1, wherein when said image of the image specimen is formed on said printing medium, said image of the dummy specimen is also formed on said printing medium, and said image of the dummy specimen is taken as a marker for determining the position of said image specimen.

4. The image forming device according to claim 3, wherein color or color density of said dummy specimen is different from that of said image specimen.

5. The image forming device according to claim 1, wherein said latent image of the dummy specimen is not developed.

6. The image forming device according to claim 1, wherein when said image of the image specimen is formed on said printing medium, said image of the dummy specimen is also formed on said printing medium, and said image of the dummy specimen shows predetermined information relating to said image specimen to a user.

7. An image forming device for conducting image formation on a printing medium by repeatedly executing a one-scan printing processing, in which an image is formed on said printing medium based on printing data, while moving a head unit in a main scanning direction, with successive displacement of a relative position with respect to said printing medium in a sub-scanning direction, wherein
when density calibration of an image formed on said printing medium is conducted, an image of an image specimen is formed on said printing medium based on said printing data for said calibration, and color of said formed image of the image specimen is measured and said image density is adjusted based on said color measurement result, and
said printing data for the calibration have data of said image specimen serving as an object of said color measurement and data of a dummy specimen whose image is formed before and after said image of the image specimen in said main scanning direction for each said one-scan printing processing for forming said image of the image specimen.

8. The image forming device according to claim 7, wherein said image of the dummy specimen is an image which is uninterrupted in said sub-scanning direction.

9. The image forming device according to claim 8, wherein said image of the dummy specimen is formed beyond a formation range of said image of the image specimen in the sub-scanning direction.

10. The image forming device according to claim 1, wherein said printing data for the calibration are provided in a host device for issuing a request for image formation to said image forming device.

11. The image forming device according to claim 1, wherein said printing data for the calibration are provided in said image forming device.

12. An image forming device for forming an image on a printing medium by forming a latent image on a photosensitive body based on printing data, developing said latent image with coloring material, and transferring said developed image onto said printing medium, wherein
when density calibration of an image formed on said printing medium is conducted, said developed image of an image specimen is formed on said photosensitive body or said image of said image specimen is formed on said printing medium based on said printing data for said calibration,
color of said formed developed image of the image specimen or said formed image of the image specimen is measured and said image density is adjusted based on said color measurement result, and
said printing data for the calibration have data of said image specimen serving as an object of said color measurement and data of a dummy specimen whose said latent image is formed before said latent image of said image specimen is formed and whose said latent image is apart from said latent image of said image specimen.

13. The image forming device according to claim 12, wherein when said image of the image specimen is formed on said printing medium, said image of the dummy specimen is also formed on said printing medium, and said image of the dummy specimen is taken as a marker for determining the position of said image specimen.

14. The image forming device according to claim 13, wherein color or color density of said dummy specimen is different from that of said image specimen.
